(19) United States
(12) Patent Application Publication
(10) Pub. No.: US 2008/0243976 A1
(43) Pub. Date: Oct. 2, 2008

(54) MULTIPLY AND MULTIPLY AND ACCUMULATE UNIT

(75) Inventor: Christian Wiencke, Oberschleisshelm (DE)

Correspondence Address: TEXAS INSTRUMENTS INCORPORATED, P O BOX 655474, M/S 3999, DALLAS, TX, 75265, US

(73) Assignee: TEXAS INSTRUMENTS DEUTSCHLAND GMBH, Freising (DE)

(21) Appl. No.: 12/057,625

(22) Filed: Mar. 28, 2008

(30) Foreign Application Priority Data
Mar. 28, 2007 (DE) 102007014808.0

(51) Int. Cl. G06F 7/523; G06F 7/57

(52) U.S. Cl. 708/230; 708/629

(57) ABSTRACT

The present invention relates to a multiply apparatus and a method for multiplying a first operand consisting of na bits and a second operand consisting of nx bits. In one embodiment the multiply apparatus comprising a CSA (CSA) unit with nx rows each comprising na AND gates for calculating a single bit product of two single bit input values and adder cells for adding results of a preceding row to a following row and a last output row for outputting a carry vector and a sum vector, and logic circuitry for selectively inverting the single bit products at the most significant position of the nx−1 first rows and at the na−1 least significant positions of the output row in response to a first configuration signal before inputting the selectively inverted single bit products to respective adder cells for switching the CSA unit selectively between processing of signed two's complement operands and unsigned operands in response to the first configuration signal. In one embodiment the method comprising outputting a carry vector and a sum vector, and adding the carry vector and the sum vector provided by the output row of the CSA unit via a CPA unit consisting of a row of na full adder cells, wherein the carry input of the CPA unit is coupled to receive a first configuration signal to switch between processing of signed and unsigned two's complement operands.

### CROSS-REFERENCE TO RELATED APPLICATIONS

The present invention claims benefit of German patent application filing number 10 2007 014 808.0, filed on Mar. 28, 2007, which is herein incorporated by reference.

### BACKGROUND OF THE INVENTION

1. Field of the invention

The present invention relates to a multiply apparatus and a method for multiplying at least two operands.

2. Description of the Related Art

Digital data processing requires multiplication and accumulation of digital data. For this purpose, digital signal processors (DSP) usually include a multiply or a multiply and accumulate (MAC) unit, which is adapted to multiply and accumulate digital operands (i.e. binary numbers) for various controlling and data processing tasks. As multiplication and accumulation of digital numbers is one of the basic and central data processing steps in all kinds of data processing applications, there is a general motivation to improve the multiply and accumulate units towards faster operation and less complexity.

The multiplication of two digital numbers is typically carried out by a series of single bit multiplications and single bit adding steps. A single bit multiplier is implemented by logic gates (typically AND gates) and the summation of two bits is carried out by half or full adder cells. A half adder cell only adds two single bits of two different operands, whereas a full adder cell is able to handle an additional carry bit. An example of such an algorithm for signed multiplication is the Baugh-Wooley method for signed multiplication. The general theory of multiplication and multiplication according to the modified Baugh-Wooley method for signed multiplication is described below.

Table 1 shows a multiplication s(7:0)=a(3:0)*x(3:0) of two 4 bit unsigned operands based on addition of four 4 bit numbers. Accordingly, the first operand a(3:0) consists of na=4 bits and the second operand x(3:0) consists of nx=4 bits. For the further considerations n is defined as n=nx=na. The term aixj represents the single bit product of the respective bits of the first and the second operand.

TABLE 1

| | | | | | | | | |
|---|---|---|---|---|---|---|---|---|
| | | | | | a₃ | a₂ | a₁ | a₀ |
| * | | | | | x₃ | x₂ | x₁ | x₀ |
| | | | | | a₃x₀ | a₂x₀ | a₁x₀ | a₀x₀ |
| | | | | a₃x₁ | a₂x₁ | a₁x₁ | a₀x₁ | |
| | | | a₃x₂ | a₂x₂ | a₁x₂ | a₀x₂ | | |
| | | a₃x₃ | a₂x₃ | a₁x₃ | a₀x₃ | | | |
| = | s₇ | s₆ | s₅ | s₄ | s₃ | s₂ | s₁ | s₀ |

Table 2 shows a signed multiplication in two's complement format according to a scheme known as modified Baugh-Wooley method.

TABLE 2

| | | | | | | | | |
|---|---|---|---|---|---|---|---|---|
| | | | | | a₃ | a₂ | a₁ | a₀ |
| * | | | | | x₃ | x₂ | x₁ | x₀ |
| | | | | | −a₃x₀ | a₂x₀ | a₁x₀ | a₀x₀ |
| | | | | −a₃x₁ | a₂x₁ | a₁x₁ | a₀x₁ | |
| | | | −a₃x₂ | a₂x₂ | a₁x₂ | a₀x₂ | | |
| | | a₃x₃ | −a₂x₃ | −a₁x₃ | −a₀x₃ | | | |
| = | s₇ | s₆ | s₅ | s₄ | s₃ | s₂ | s₁ | s₀ |

According to the modified Baugh-Wooley method for signed multiplication, the negative entries in the matrix can be substituted by bit-inverted entries and some additional entries. In Baugh-Wooley method for signed multiplication, the following substitutions are made: the negative entries in the matrix can be substituted by bit-inverted entries and some additional entries.

Thus, the following substitutions are made:

−a₃xₖ=(1−a₃xₖ)−1=not(a₃xₖ)−1

−aₖx₀=(1−aₖx₀)−1=not(aₖx₀)−1

Table 3 shows the signed multiplication of two 4 bit numbers when the above substitutions are applied to Table 2.

TABLE 3

| | | | | | | | | |
|---|---|---|---|---|---|---|---|---|
| | | | | | a₃ | a₂ | a₁ | a₀ |
| * | | | | | x₃ | x₂ | x₁ | x₀ |
| | | | | | /a₃x₀ | a₂x₀ | a₁x₀ | a₀x₀ |
| | | | | /a₃x₁ | a₂x₁ | a₁x₁ | a₀x₁ | |
| | | | /a₃x₂ | a₂x₂ | a₁x₂ | a₀x₂ | | |
| | | a₃x₃ | /a₂x₃ | /a₁x₃ | /a₀x₃ | | | |
| | | | −1 | −1 | −1 | | | |
| | | | −1 | −1 | −1 | | | |
| = | s₇ | s₆ | s₅ | s₄ | s₃ | s₂ | s₁ | s₀ |

In Table 3, /aᵢxᵢ is not(aᵢxᵢ). The “−1” entries result from the above substitutions and each “−1” relates to one /aᵢxᵢ−1 entry. All “−1” entries are split off from the /aᵢxᵢ−1 entry and placed in the last two rows. The “−1” entries can be combined to “−112” or “−128”+16”, or generally for multiplication of n-bit values the “−1” entries can be combined as follows:

(−1−1)*2²ⁿ⁻³+ . . . +(−1−1)*2ⁿ⁻¹=−2²ⁿ⁻²− . . . −2ⁿ=−2²ⁿ⁻¹+2ⁿ

So a “1” has to be added to column n and a “−” has to be added to column 2n−1 of the matrix. Because the result has the two's complement format the “−1” in column 2n−1 (=sign digit) changes to “1”. Table 4 shows the complete matrix for a 4 bit signed multiplication.

The scheme of Table 4 is known as modified Baugh-Wooley method.

TABLE 4

| | | | | | | | | |
|---|---|---|---|---|---|---|---|---|
| | | | | | a₃ | a₂ | a₁ | a₀ |
| * | | | | | x₃ | x₂ | x₁ | x₀ |
| | | | | | /a₃x₀ | a₂x₀ | a₁x₀ | a₀x₀ |
| | | | | /a₃x₁ | a₂x₁ | a₁x₁ | a₀x₁ | |
| | | | /a₃x₂ | a₂x₂ | a₁x₂ | a₀x₂ | | |
| | | a₃x₃ | /a₂x₃ | /a₁x₃ | /a₀x₃ | | | |
| | 1 | | | 1 | | | | |
| = | s₇ | s₆ | s₅ | s₄ | s₃ | s₂ | s₁ | s₀ |

Now a MAC (multiply and accumulate) operation s=a*x+t is considered. Compared to the multiplication an additional row for the accumulator t is added to the scheme. An unsigned MAC operation of two 4 bit factors and an 8 bit accumulator looks as follows:

s(8:0)=a(3:0)*x(3:0)+t(7:0)

Table 5 shows the scheme for unsigned MAC operation of two 4 bit factors and an 8 bit accumulator.

TABLE 5

| | | | | | | | | | |
|---|---|---|---|---|---|---|---|---|---|
| | | | | | | a₃ | a₂ | a₁ | a₀ |
| * | | | | | | x₃ | x₂ | x₁ | x₀ |
| + | | t₇ | t₆ | t₅ | t₄ | t₃ | t₂ | t₁ | t₀ |
| | | | | | | a₃x₀ | a₂x₀ | a₁x₀ | a₀x₀ |
| | | | | | a₃x₁ | a₂x₁ | a₁x₁ | a₀x₁ | |
| | | | | a₃x₂ | a₂x₂ | a₁x₂ | a₀x₂ | | |
| | | | a₃x₃ | a₂x₃ | a₁x₃ | a₀x₃ | | | |
| | | t₇ | t₆ | t₅ | t₄ | t₃ | t₂ | t₁ | t₀ |
| = | s₈ | s₇ | s₆ | s₅ | s₄ | s₃ | s₂ | s₁ | s₀ |

For signed MAC operation the same modified Baugh-Wooley method is used as done for the multiply operation. The resulting scheme is depictured in Table 6. The signed digit of the accumulator (t₇) and the “1” in column 7 have to be sign-extended.

TABLE 6

| | | | | | | | | | |
|---|---|---|---|---|---|---|---|---|---|
| | | | | | | a₃ | a₂ | a₁ | a₀ |
| * | | | | | | x₃ | x₂ | x₁ | x₀ |
| + | | t₇ | t₆ | t₅ | t₄ | t₃ | t₂ | t₁ | t₀ |
| | | | | | | /a₃x₀ | a₂x₀ | a₁x₀ | a₀x₀ |
| | | | | | /a₃x₁ | a₂x₁ | a₁x₁ | a₀x₁ | |
| | | | | /a₃x₂ | a₂x₂ | a₁x₂ | a₀x₂ | | |
| | | | a₃x₃ | /a₂x₃ | /a₁x₃ | /a₀x₃ | | | |
| | 1 | 1 | | | 1 | | | | |
| | t₇ | t₇ | t₆ | t₅ | t₄ | t₃ | t₂ | t₁ | t₀ |
| = | s₈ | s₇ | s₆ | s₅ | s₄ | s₃ | s₂ | s₁ | s₀ |

As the operations to be carried out for unsigned and signed multiplication are different, the schemes of Table 1 and Table 4 are implemented in a parallel architecture including the circuits of FIG. 1 and FIG. 2. FIG. 1 is an example for a 4×4 bit unsigned multiplier and FIG. 2 is an example for a 4×4 bit signed multiplier. The partial products are added in a carry save adder (CSA) array with a completing carry propagate adder (CPA). The “1”-s shown in Tables 4 and 6 are added in an additional cycle in the CPA unit or in an additional adder unit. Accordingly, the prior art solution is complex, requires additional clock cycles and is area consuming when implemented on an integrated circuit.

### SUMMARY OF THE INVENTION

Embodiments of the present invention generally relate to a multiply apparatus and a method for multiplying a first operand consisting of na bits and a second operand consisting of nx bits.

In one embodiment the multiply apparatus comprising a carry save adder (CSA) unit with nx rows each comprising na AND gates for calculating a single bit product of two single bit input values and adder cells for adding results of a preceding row to a following row and a last output row for outputting a carry vector and a sum vector, and logic circuitry for selectively inverting the single bit products at the most significant position of the nx−1 first rows and at the na−1 least significant positions of the output row in response to a first configuration signal (tc) before inputting the selectively inverted single bit products to respective adder cells for switching the CSA unit selectively between processing of signed two's complement operands and unsigned operands in response to the first configuration signal (tc). In another embodiment, the method comprising outputting a carry vector and a sum vector, and adding the carry vector and the sum vector provided by the output row of the CSA unit via a CPA unit consisting of a row of na full adder cells, wherein the carry input of the CPA unit is coupled to receive a first configuration signal (tc) to switch between processing of signed and unsigned two's complement operands.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a 4×4 bit unsigned parallel carry save adder (CSA) array multiplier;

FIG. 2 is a 4×4 bit signed parallel CSA array multiplier;

FIG. 3 is a 4×4 bit selectable signed/unsigned parallel CSA array multiplier;

FIG. 4 is a 4×4 bit unsigned parallel CSA array and MAC unit;

FIG. 5 is a 4×4 bit selectable signed/unsigned parallel CSA array MAC unit according to the present invention;

FIG. 6 is a 16×4 bit CSA array slice for a selectable signed/unsigned multiplication and MAC unit according the present invention; and

FIG. 7 shows a 16×16 bit selectable signed/unsigned partially serialized multiplier and MAC unit according the present invention.

### DETAILED DESCRIPTION

The embodiments of the present invention provide a multiply apparatus and a MAC unit for processing singed and unsigned operands, which may result in a smaller in size and less complex multiply apparatus.

In one embodiment, a multiply apparatus for multiplying a first operand consisting of na bits and a second operand consisting of nx bits is provided. The multiply apparatus includes a carry save adder (CSA) unit with nx rows each including na stages of logic gates for calculating a single bit product of two single bit input values and adder cells for operable coupling successive rows for adding results of a preceding row to a following row and a last output row for outputting a carry vector and a sum vector.

Additional logic circuitry is provided to selectively invert the single bit products at the most significant position of the nx−1 first rows. Such logic circuitry also inverts the single bit products at the na−1 least significant positions of the output row. The inversion may occur in response to the first configuration signal and before inputting the inverted single bit products to respective adder cells. In response to the first configuration signal, the CSA unit may switch selectively between processing of signed two's complement operands and unsigned operands.

These modifications of the CSA unit allow for using the same CSA unit for signed and unsigned multiplication. Inverting the single bit products at the specific positions of the CSA unit renders it possible to use the entire CSA unit for signed and unsigned multiplication by simply switching the first configuration signal between two states (for example a logic “1” or a logic “0”). Inverting a single bit value can be implemented by an XOR gate. One input of the XOR gate receives the single bit value to be inverted and the other input is coupled to receive the first configuration signal.

If the first configuration signal is logic ‘1’, the output of the XOR gate produces the inverted single bit value. If the first configuration signal is logic ‘0’, the XOR passes the single bit input value unchanged. The adder cells may be half or full adder cells depending on the particular implementation of the CSA unit.

Where possible, adder cells can be omitted. For example, the first row of the CSA unit and the most significant positions of each row may only consist of logic gates for calculating the single bit products. The specific number and location of adder cells depends also on whether a multiply or a MAC unit implemented. As signed and unsigned multiplication can be performed by the same multiply apparatus, there is no need to implement a whole CSA unit for signed and another CSA unit for unsigned multiplication. So, the required chip area is reduced to half the area needed for conventional solutions.

Since standard logic gates can be used, the multiply apparatus may be implemented based on any standard library of digital logic cells of a specific CMOS technology, or any other technology. In particular, there is no need to modify the digital gates, like full or half adder cells in order to implement the modified Baugh-Wooley algorithm.

The multiply apparatus can further be adapted to add a third operand to the product of the first and second operand so as to perform a multiply and accumulate operation. In order to add the third operand, the first row of the CSA unit includes for example at least na half adder cells. If more than one additional operand is to be added, it can be useful to use na full adder cells. By such a modification, the multiply apparatus is basically transformed into a multiply and accumulate (MAC) unit. Respective registers to store operands and intermediate results can also be added. Also the MAC unit profits from the very regular structure according to the present invention. It can be implemented by logic standard cells in any technology.

Also, the multiply apparatus or MAC unit according to the present invention for multiplying a first operand consisting of na bits and a second operand consisting of nx bits, may include a CSA unit according to the invention as set out here above or any conventional adder unit outputting a carry vector and a sum vector. The multiply or MAC unit includes a carry propagate adder (CPA) unit consisting of a row of na full adder cells for adding the carry vector and the sum vector provided by the output row of the CSA unit. For a mere multiply apparatus the CPA unit may consist only of na−1 full adder cells. For both, the multiply and the MAC unit the carry input of the CPA unit is coupled to receive a first configuration signal to switch between processing of signed and unsigned two's complement operands.

Further, a first XOR gate may be coupled to the full adder cell at the most significant position of the CPA unit. An input of the first XOR gate is coupled to the carry output of the full adder cell and the other input of the first XOR gate is coupled to receive the first configuration signal. The output of the first XOR gate is the MSB of the ready sum vector.

Also, for the MAC unit according to the present invention, the adder cell at the most significant position of the CPA unit may be coupled to a second XOR gate. An output of the second XOR gate is coupled to a summing input of the full adder cell. One input of the second XOR gate is coupled to receive the MSB of the third operand, and another input of the second XOR gate receives the first configuration signal in order to switch between singed and unsigned operation.

The first and second XOR gates coupled to the full adder cell at the most significant position of the CPA unit implement addition of either one or two ‘1’-s, which are to be added at the most significant positions in the CPA unit for signed two's complement operation (cf. Table 4 and 6 for multiply and MAC unit, respectively). The carry input of the CPA unit is coupled to the first configuration signal to carry out the addition of a ‘1’ at position na, as shown in Tables 4 and 6. A CPA unit according to the present invention allows for adding the additional ‘1’-s of the modified Baugh-Wooley method in a single step. Using the carry input of the full adder cell at the least significant position allows for adding a ‘1’ at the correct position, without any modification of the CPA of the full adder cells included in the CPA and without any extra clock cycle.

Further, the additional logic coupled to the full adder cell at the most significant position allows for adding the necessary ‘1’-s without additional adder cells, adding steps or the like. Accordingly, a multiplier having a CPA unit according to the present invention allows for switching from multiplying unsigned operands to signed operands according to the modified Baugh-Wooley, with very small additional circuitry.

The multiply or the MAC unit according to the present invention may be further adapted to multiply the first operand and a fourth operand consisting of nb bits. For the present invention nb is equal na. According to this implementation, the multiply or MAC unit includes a first register for receiving the carry vector and a second register for receiving the sum vector from the last output row of the CSA unit. Further, there is a first multiplexer for successively inputting nx bit wide portions of the fourth operand to the carry save unit, wherein nb is ns times nx and ns is a positive integer in order to process the entire multiplication in ns slices. One slice for each portion of the fourth operand is thereby consecutively calculated in order to calculate a product of the first operand and the fourth operand to be finalized after the last slice.

A first feedback connection couples the first register and the second register back to the CSA unit for feeding back the temporary sum vector and the temporary carry vector to the CSA unit for processing of the respective following slice. A second feedback connection couples the CPA unit to the second register for feeding back the summing result in the CPA to the most significant part of the second register in order to provide the final result in the second register. Eventually, logic circuitry for switching the CSA unit, selectively between processing of the last slice and previous slices in response to a second configuration signal is provided.

Accordingly, the single bit products at the na−1 least significant positions of the last row are only inverted for the last slice of a signed two's complement operation and the single bit product at the most significant position of the last row is always inverted for signed two's complement operation except for the last slice. This aspect of the present invention, allows for partially serializing the operation. The fourth operand is divided in several nx bit wide portions, and the part of the multiplication except the final addition of carry and sum vector in a CPA is carried out for each of the portions (slices). According to this aspect of the invention, the part of the multiplication of two operands (e.g. na=nb=16 and nx=4) except the final addition of the carry and the sum vector in a CPA can be partially serialized into four slices.

Since the CSA unit is configurable by the first configuration signal to operate on signed or unsigned operands, the same CSA unit can be used for all the slices of a complete multiplication. Only the last slice requires inverting the single bit products in the last row. So, for signed operation the last row operates ns−1 times with nx similarly configured rows and only for the last slice with a differently configured last row. The reusability of the same CSA unit for all slices combined with the general capability of switching between signed and unsigned operation provides for substantive chip area reduction.

According to the present invention, it is generally possible to use the same CSA unit in combination with the final CPA unit for the varying multiplication operations thereby providing a multiplication result for a complete first and fourth operand. The multiply apparatus (or MAC unit) according to the present invention does not require an extra row of adder cells or extra clock cycles for the signed operation. Also, only standard full adder cells can be used, which are normally available in libraries of digital logic cells. Modifications of the standard full adder cells are not necessary. The MAC unit provides for a selectable signed and unsigned multiplication or the multiply and accumulate operation with a small gate count. Accordingly, the required chip area and the power consumption are reduced; the possible operation frequency can be high. Eventually, the regular structure simplifies implementation.

Each row of a CSA unit according to the present invention includes the same number of full adder cells and AND gates. Each of the full adder cells is coupled to a corresponding AND gate. The AND gate implements the single bit multiplication. The so produced single bit product output by the AND gate is either directly input to a summing input of the full adder cell or indirectly via an XOR gate as set out above. Using such a regular structure for the CSA unit renders implementation easier. The multiply apparatus, which is merely used for multiplication and not for accumulation may have one full adder less per row.

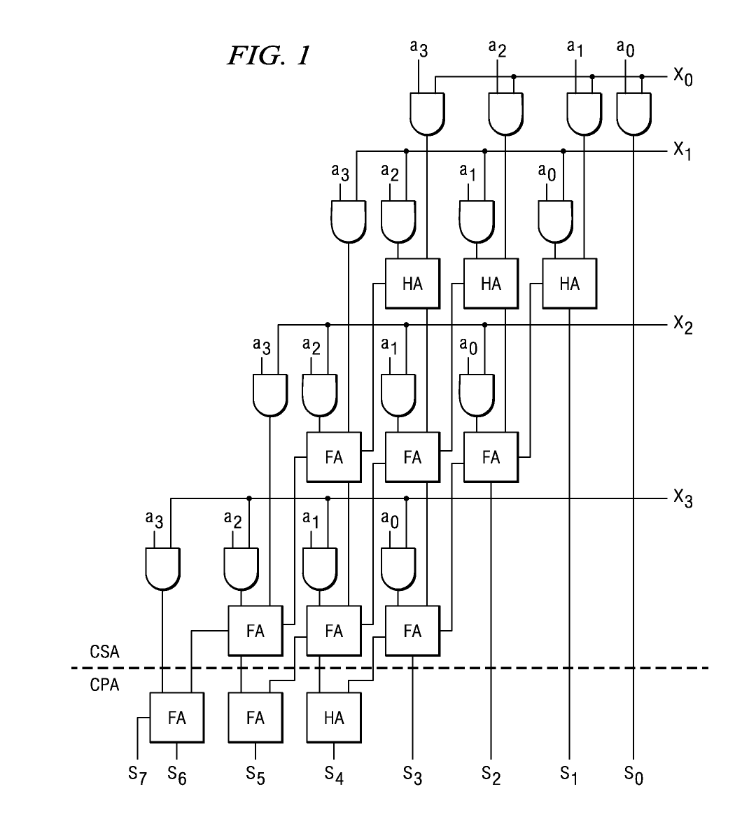

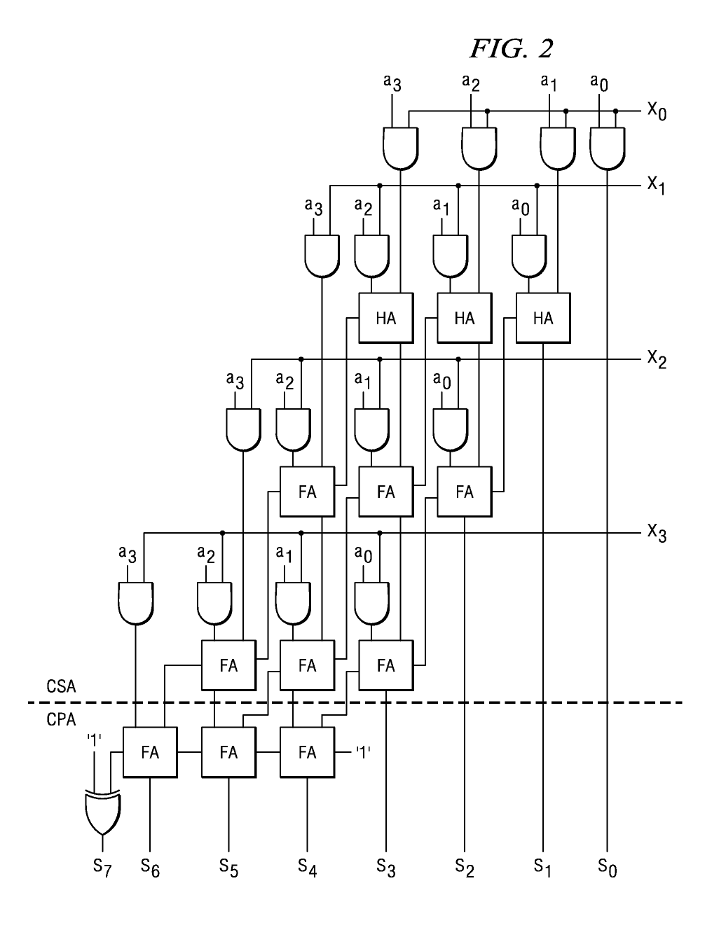

FIG. 1 shows a 4×4 bit unsigned parallel CSA array multiplier. The schemes for unsigned and signed multiplication indicated in the above Tables 1 and 4 can be used for partial product generation in a parallel multiplier. In order to add the partial products, a CSA array is used with a completing CPA unit. FIGS. 1 and 2 represent respective parallel multipliers for a bit size of 4. A first operand a(3:0) consisting of na=4 bits, and a second operand x(3:0) consisting of nx=4 bits are multiplied in FIG. 1 to produce the final product s(7:0). A full adder cell is indicated by FA and a half adder cell by HA.

The implementation of the signed multiplier shown in FIG. 2 is based on the modified Baugh-Wooley method as described here above with respect to Table 4. The two “1”-s which have to be added to the result are added using the carry input of the completing CPA and an additional XOR gate for generating the most significant bit (MSB) of the result.

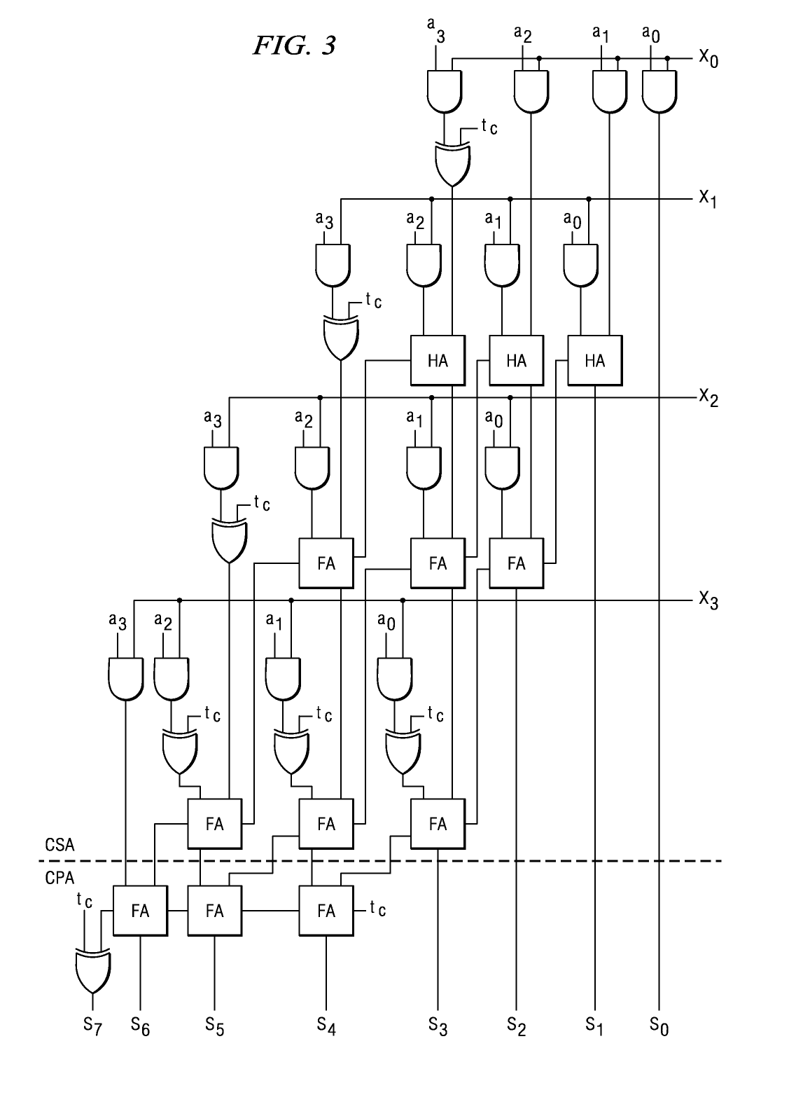

FIG. 3 shows a circuit which is adapted according to the present invention to carry out unsigned and signed multiplication of two 4 bit operands. The input signal is the first configuration signal tc, which is used for selecting between unsigned operation (tc=0) and signed operation (tc=1) of the multiply apparatus. The format used in the present description for representing signed digital numbers is the two's complement format. As indicated in FIG. 3, the most significant positions of each row of the CSA unit, except the last row, and the most significant position of the CPA unit are coupled to the first configuration signal tc. Further, the full adder cells FA of the last row of the CSA unit and the full adder cell FA at the least significant position of the CPA unit are also coupled to the input signal tc to selectively carry out signed and unsigned operations. At positions na−1 in the nx−1 first rows and at the na−1 least significant positions of the last row, the coupling is carried out by an XOR gate coupled to an output of the AND gates. The AND gates produce the single bit product at the respective position. The XOR gate serves to invert the single bit product for tc=1. For the multiply apparatus of FIG. 3, the output of an XOR gate at the most significant positions of each of the nx−1 first rows is not coupled to an adder in the same row but in the respective following row.

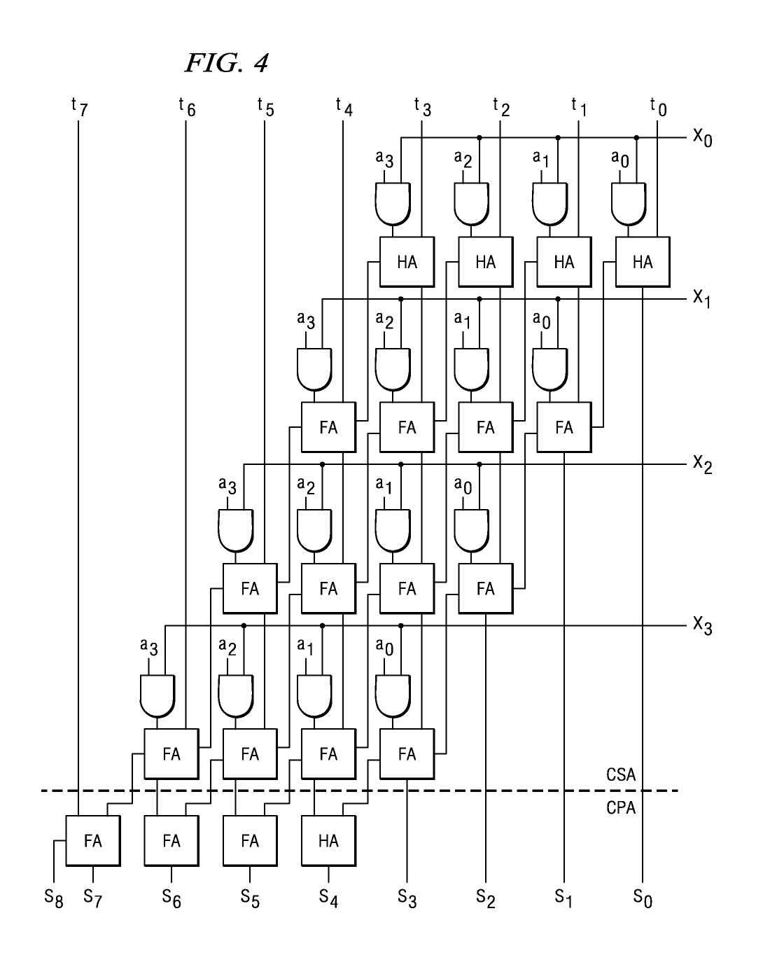

FIG. 4 shows a 4×4 bit unsigned parallel CSA array and the MAC unit corresponding to the scheme shown in Table 5. Accordingly, a third operand t(7:0) can be added to carry out a complete multiply and accumulate operation of two four bit operands and an eight bit operand.

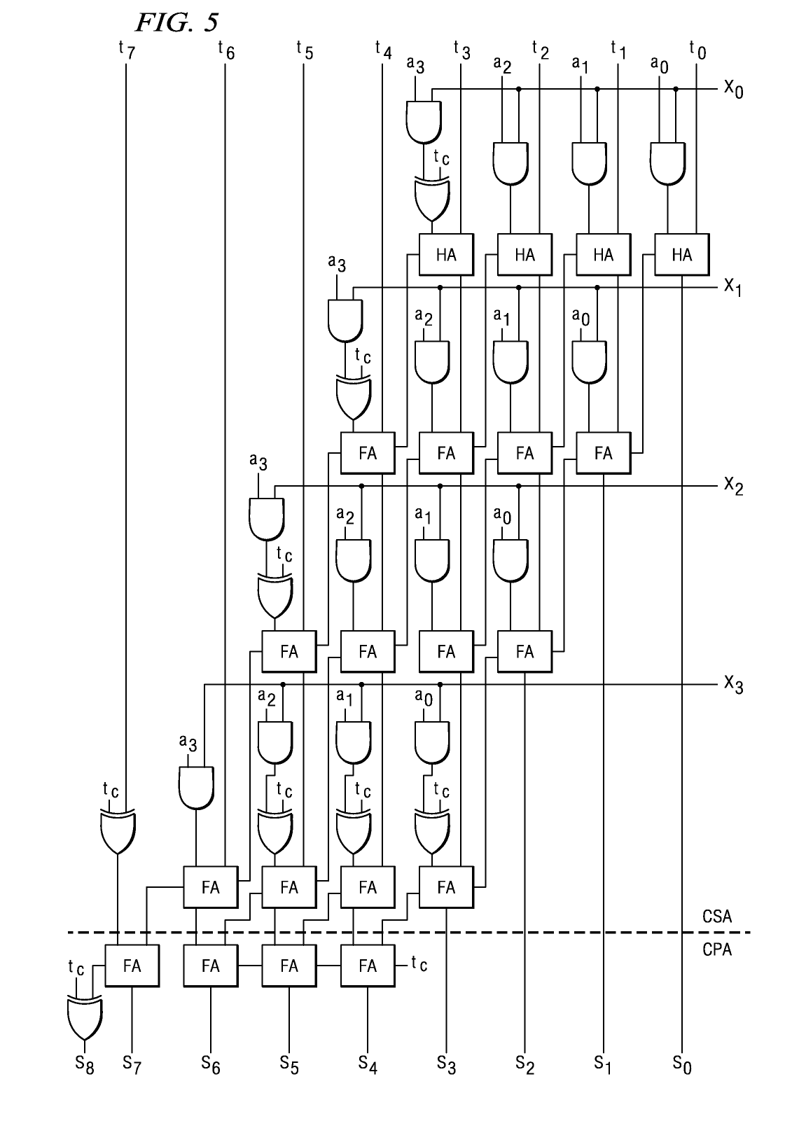

The circuit shown in FIG. 5 relates to Table 6 and is a 4×4 bit selectable signed/unsigned parallel CSA array MAC unit, which has been optimized according to aspects of the present invention. The resulting architecture shown in FIG. 5 is a very regular array of adder cells having a first row of half adder cells HA and the remaining rows of full adder cells FA. Each preceding row is coupled to a following row of adder cells. Each adder cell at the most significant position (i.e. at na−1=3) of the na−1=3 first rows and at the most significant position of the CPA unit is coupled to the input signal tc via an XOR gate.

Further, each full adder cell FA at the na−1=3 least significant positions of the last output row of the CSA unit is coupled to the input signal tc via an XOR gate. The XOR gates invert the respective single bit product provided by the AND gates. A ‘1’ at positions 7 and 8 (S7, S8) of the CPA unit is added to the result. The carry input of the FA at the least significant position of the CPA unit is coupled to tc in order to perform the summation of a ‘1’ at the specific position (S4). The generation of the output signal s8 has been optimized according to the following equations

Accordingly, only one XOR gate is necessary to determine S8.
s8=c_out7 XOR (t7 AND tc) XOR [(t7 AND tc) XOR tc]
s8=c_out7 XOR (t7 AND tc) XOR
   {[(t7 AND tc) AND /tc] OR [/t7 AND tc) AND tc]}
s8=c_out7 XOR (t7 AND tc) XOR [/t7 OR /tc) AND tc]
s8=c_out7 XOR (t7 AND tc) XOR (/t7 AND tc)
s8=c_out7 XOR tc

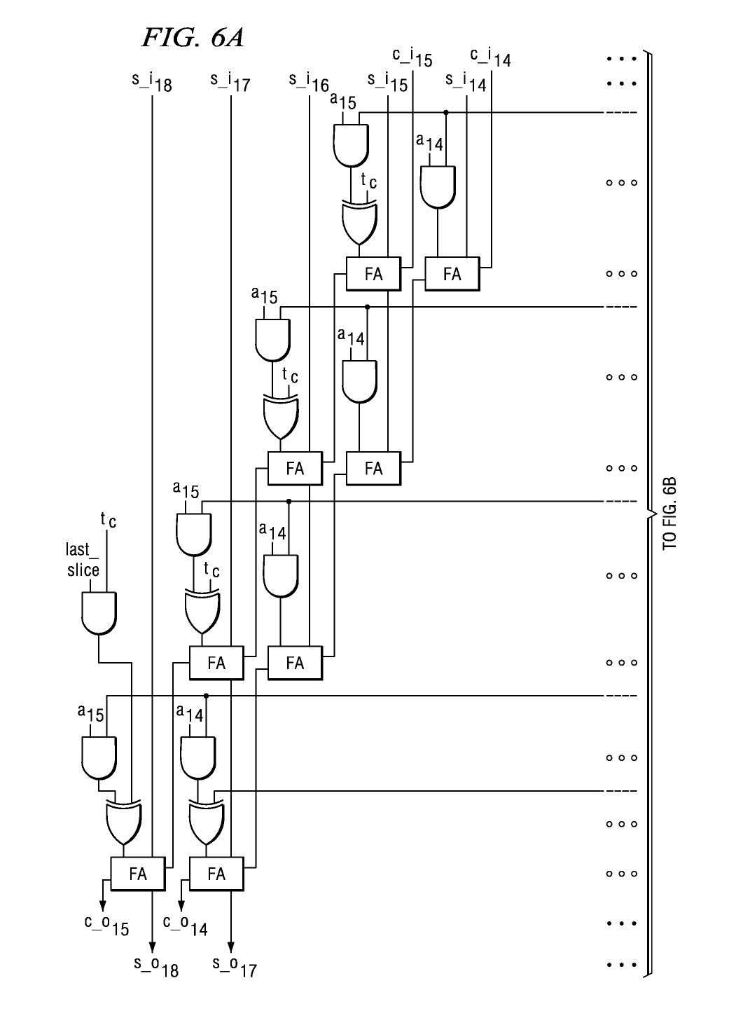

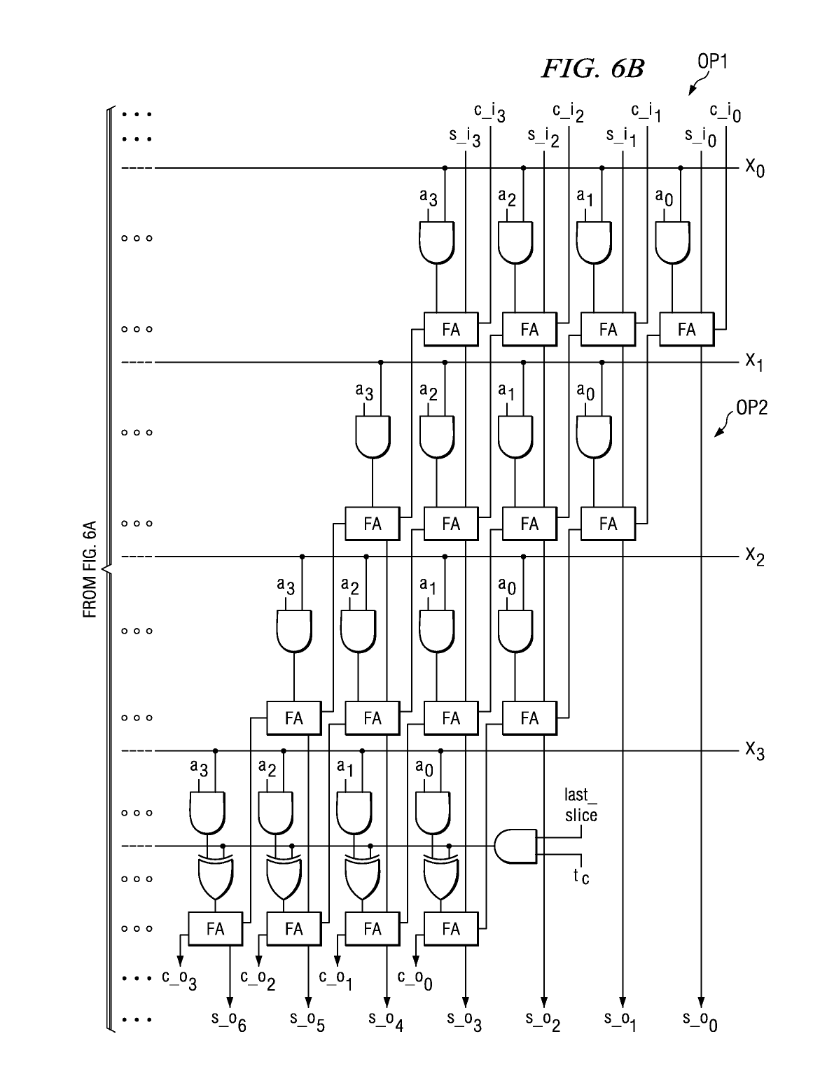

FIG. 6A and 6B shows a 16×4 bit CSA unit for selectable signed/unsigned multiplication and MAC operation according to the present invention. The multiply or MAC unit according to the present invention can be partially serialized. Serialization can be useful to reduce chip area, power consumption and critical path delay. Accordingly, during each clock cycle of a clock signal applied to the circuit only a part of the whole operation is carried out by the same unit. The structure of the CSA unit having the required extension for signed operations is highly regular and therefore suitable to be split without increasing substantially the complexity of the circuit or the chip area.

The multiplication of two operands OP1 consisting of na=16 bits and OP4 consisting of nb=16 bits is considered to be split into slices of a bit width of nx=4 bit. According to the present embodiment a 16×16 bit signed/unsigned multiply or MAC operation can be split into four 16×4 bit slices. For a signed operation the single bit products at positions 0 to 14 (0 to na−2) of the last row (nx−1) have to be inverted and the single bit product at position 15 (na−1) of the last row (nx−1) is not inverted. For the partially serialized operation this applies only to the last slice which is implemented by additional logic using the second configuration signal last_slice as shown in FIG. 6A and 6B. Further, the single bit products at the most significant positions of the nx−1 first rows are selectively inverted in response to the first configuration signal tc.

Accordingly, a first operand having na bits (where na is for example 16 bit) may be multiplied by a fourth operand OP4 having nb bits (where nb is for example 16 bit), in multiple slices of nx (e.g. nx=4 bit) bits of the fourth operand. Each part of nx bits may then be considered as a second operand OP2, which is basically handled as set out above. The signed multiplication and accumulation uses the modified Baugh-Wooley method in combination with a CSA unit and a completing CPA unit, wherein the carry input of the full adder cell at the least significant position of the CPA unit is used for supplying an additional “1” in order to implement the modified Baugh-Wooley.

The selectable signed and unsigned multiplication and accumulation based on the modified Baugh-Wooley method combined with this CSA unit and a completing CPA unit with the particularity of using the carry input of the completing CPA unit and additional XOR gates for the additional “1” bit values of the modified Baugh-Wooley method represents an improved implementation principle. The approach of partial serialization of the CSA unit and the completing CPA unit having an extension for the modified Baugh-Wooley method and for the additional logic for selecting between signed and unsigned operations reduces complexity, saves chip area and power.

According to the present invention, no additional rows of adder cells or additional clock cycles are needed for signed operation. Only standard full adder cells are used, which are usually available in standard libraries. Modifications of standard full adder cells are not necessary.

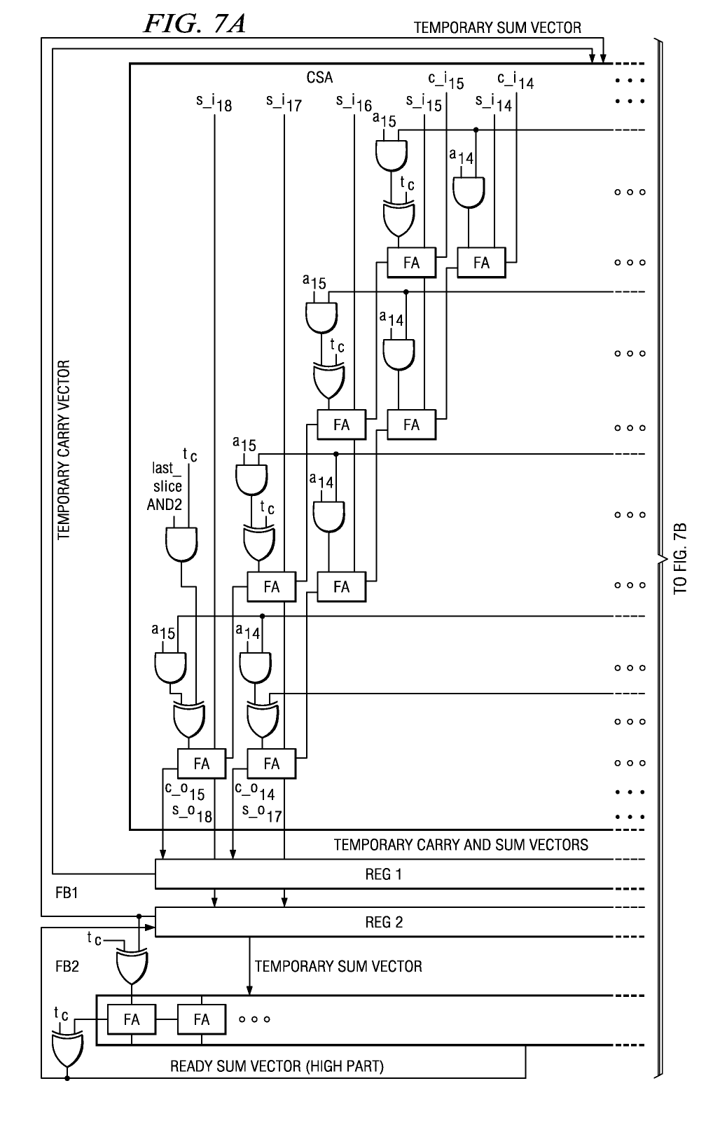

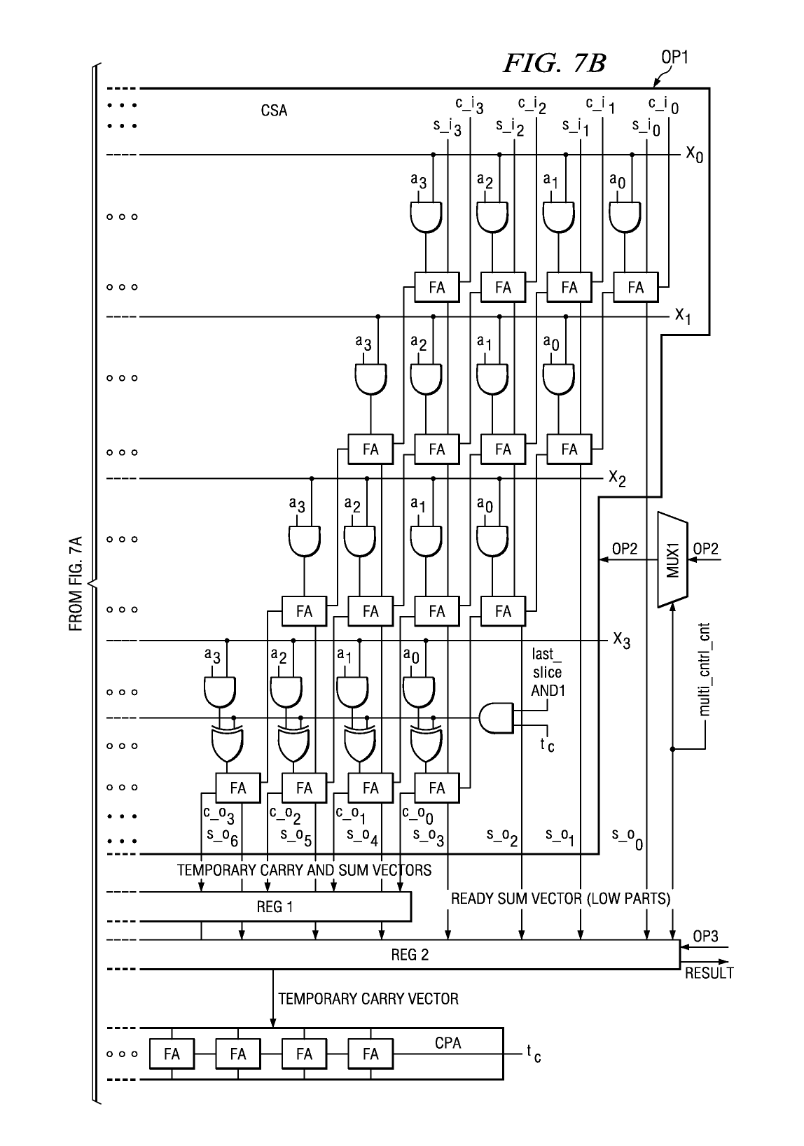

FIG. 7A and 7B shows a simplified diagram of a 16×16 bit selectable signed and unsigned partially serialized multiplier and MAC unit according to the present invention. The basic components are the CSA unit, the CPA unit, the registers REG1 and REG2 and multiplier MUX1.

The temporary carry and sum vectors output by the last output row of the CSA unit are saved in a first register REG1 and a second register REG2. In order to save chip area, the CSA unit is used four times (four slices) by feeding back the temporary carry and sum vectors via feedback lines FB1 to corresponding inputs of the CSA unit. The first operand OP1 is input to the na=16 inputs ai of the CSA unit. The fourth operand OP4 consisting of nb=16 bits is input to the first multiplexer MUX1 and sequentially divided into parts of nx=4 bits. Each of those parts is further processed as a second operand OP2. For each slice, the second operand OP2 consisting of nx=4 bits is input to inputs xi of the CSA unit.

The switching between signed and unsigned operation is performed as follows. The full adder cells FA at the most significant positions of each row of the CSA unit (i.e. on the left hand side of each row) and all full adder cells FA of the last row of the CSA unit are coupled to receive the first configuration signal tc indicating signed or unsigned operation. The last row of the CSA unit is also coupled to receive a second configuration signal last_slice in order to distinguish calculation of preceding slices from the last slice.

The logic coupling of tc and last_slice is done by AND and XOR gates. The XOR gates are used to invert the single bit products provided at the outputs of the AND gates at the respective positions in response to tc=1. For tc=0, the output signal of the respective AND gate is transferred unchanged through the XOR gate. The AND gate AND1 logically coupling tx and the second configuration signal last_slice has the effect that signed operation is only performed for last_slice=1. The AND gate AND2 provides that the single bit product at position na−1=15 is only inverted if last_slice=0 and tc=1, i.e. for signed operation, but not for the last slice.

For high throughput pipelining of CSA units, similar to the one shown in FIG. 7A and 7B, with temporary registers between the units instead of partial serialization may be implemented. Further, the size of the CSA unit and therefore the number of runs necessary to carry out the whole operation may be varied for increased calculation speed.

The CPA unit consists of a row of 16 full adder cells FA. The full adder cell FA at the least significant position is coupled to receive the first configuration signal tc in order to switch between signed and unsigned operation. Accordingly, a ‘1’ is added at position na=16 of the final result for tc=1. Further, the full adder cell FA at the most significant position na+nb−1=2*n−1=31 is also coupled via an XOR gate to the first input signal tc and the carry output of the full adder cell is combined by an XOR gate with the first configuration signal tc. The function of the two XOR gates has been explained with respect to FIG. 5. They provide that a ‘1’ is added at position 31 and position 32 of the final result as required by the modified Baugh-Wooley algorithm and sign extension. The ready sum vector provided by the CPA unit can be passed to the second register REG2 having 33 bit.

The start sum vector in REG2 is the accumulator of the previous operation or a specific value (third operand OP3) can be written into the register. For a mere multiply operation, REG2 is reset to zero when the operation starts. The start carry vector in REG1 is always zero. The 16×4 bit CSA unit is used in the first operation cycles (e.g. four cycles in FIG. 7A and 7B). The temporary carry and sum vectors are saved in respective carry and result registers REG1, REG2. After each slice, the low part of the sum output of the CSA unit is ready and directly passed to register REG2 (these are the least significant four bits of the CSA unit as shown in FIG. 7A and 7B). The ready sum vector and the remaining accumulator bits are shifted in REG2 by the number of rows in the CSA unit.

After the last slice in the CSA unit, the temporary carry vector and the temporary sum vector are added in the completing CPA unit. The remaining MSB of the accumulator is also added to the result. In the embodiment shown in FIG. 7A and 7B, this final summation is done in one cycle by the 16 CPA unit, for example a 16 bit ripple carry adder. This operation may also be partially serialized using a smaller CPA and more clock cycles. In case of a signed operation, the addition of “1” bit values according to the modified Baugh-Wooley method is done with the carry input of the full adder cell FA at the least significant position of the completing CPA unit and two additional XOR gates coupled to the full adder cell FA at the most significant position. The result is passed to the upper part (17 MSBs) of REG2 via feedback path FB2. The 16 LSBs are directly stored into REG2 during the four slices of the CSA unit.

The concept according to the present invention is flexible in terms of clock cycles and chip area and can be adapted easily, by adapting for example the size of the CSA unit and thereby the number of clock cycles for a single segment operation.

What is claimed is:

1. A multiply apparatus for multiplying a first operand consisting of na bits and a second operand consisting of nx bits, the multiply apparatus comprising:
a CSA unit with nx rows each comprising na AND gates for calculating a single bit product of two single bit input values and adder cells for adding results of a preceding row to a following row and a last output row for outputting a carry vector and a sum vector; and
logic circuitry for selectively inverting the single bit products at the most significant position of the nx−1 first rows and at the na−1 least significant positions of the output row in response to a first configuration signal (tc) before inputting the selectively inverted single bit products to respective adder cells for switching the CSA unit selectively between processing of signed two's complement operands and unsigned operands in response to the first configuration signal (tc).

2. The multiply apparatus of claim 1 further comprising a CPA unit being coupled to the output row of the CSA unit, the CPA unit consisting of a row of na−1 full adder cells for adding the carry vector and the sum vector provided at the output row of the CSA unit, wherein the carry input of the CPA unit is coupled to receive the first configuration signal to switch between processing of signed and unsigned two's complement operands.

3. The multiply apparatus of claim 2, wherein the full adder cell at the most significant position of the CPA unit is coupled to a first XOR gate being coupled by a first input to the carry output of the full adder cell and by a second input to receive the first configuration signal, such that the output of the first XOR gate outputs the MSB of a ready sum vector.

4. A multiply apparatus for multiplying a first operand consisting of na bits and a second operand consisting of nx bits and for accumulating a third operand to the product, the multiply apparatus comprising:
a CSA unit with nx rows each comprising na AND gates for calculating a single bit product of two single bit input values and adder cells for adding results of a preceding row to a following row and a last output row for outputting a carry vector and a sum vector, wherein the CSA unit is further adapted to add a third operand to the product of the first and second operand so as to perform a multiply and accumulate operation; and
logic circuitry for selectively inverting the single bit products at the most significant position of the nx−1 first rows and at the na−1 least significant positions of the output row in response to a first configuration signal before inputting the selectively inverted single bit products to respective adder cells for switching the CSA unit selectively between processing of signed two's complement operands and unsigned operands in response to the first configuration signal.

5. The multiply apparatus of claim 4 further comprising a CPA unit being coupled to the output row of the CSA unit, the CPA unit consisting of a row of na full adder cells for adding the carry vector and the sum vector provided at the output row of the CSA unit, wherein the carry input of the CPA unit is coupled to receive the first configuration signal to switch between processing of signed and unsigned two's complement operands.

6. The multiply apparatus of claim 5, wherein the full adder cell at the most significant position of the CPA unit is coupled to a first XOR gate being coupled by a first input to the carry output of the full adder cell and by a second input to receive the first configuration signal, such that the output of the first XOR gate outputs the MSB of a ready sum vector.

7. The multiply apparatus of claim 6, wherein the full adder cell at the most significant position of the CPA unit is coupled to a second XOR gate, an output of the second XOR gate being coupled to a summing input of the full adder cell, one input of the second XOR gate being coupled to receive the MSB of the third operand, and another input of the second XOR gate being coupled to receive the first configuration signal in order to switch between singed and unsigned operation.

8. The multiply apparatus according to one of claims 4, wherein each row of the CSA unit comprises the same number of full adder cells and AND gates.

9. The multiply apparatus of claim 4, wherein the multiply apparatus is adapted to multiply the first operand and a fourth operand consisting of nb=na bits, the multiply apparatus comprising a first register for receiving the carry vector and a second register for receiving the sum vector from the last output row of the CSA unit, and wherein the multiply apparatus comprising:
a first multiplexer for successively inputting nx bit wide portions of the second operand to the carry save unit, wherein nb is ns times nx, ns being a positive integer in order to process the entire multiplication in ns slices, one slice for each portion of the second operand thereby consecutively calculating a product of the first operand and the second operand to be finalized after the last slice;
a first feedback connection coupling the first register and the second register back to the CSA unit for feeding back the temporary sum vector and the temporary carry vector to the CSA unit for processing of the respective following slice; and
logic circuitry for switching the CSA unit selectively between processing of the last slice and previous slices in response to a second configuration signal (last_slice), such that the single bit products at the na−1 least significant positions of the last row are only inverted for the last slice of a signed two's complement operation and the single bit product at the most significant position of the last row is always inverted for signed two's complement operation except for the last slice.

10. The multiply apparatus of claim 9 further comprising a second feedback connection coupling the CPA unit to the second register for feeding back the summing result in the CPA to the most significant part of the second register.

11. A multiply apparatus for multiplying a first operand consisting of na bits and a second operand consisting of nx bits, the multiply apparatus comprising:
an adder unit outputting a carry vector and a sum vector; and
a CPA unit consisting of a row of na full adder cells for adding the carry vector and the sum vector provided by the output row of the CSA unit, wherein the carry input of the CPA unit is coupled to receive a first configuration signal to switch between processing of signed and unsigned two's complement operands.

12. The multiply apparatus of claim 11, wherein the full adder cell at the most significant position of the CPA unit is coupled to a first XOR gate being coupled by a first input to the carry output of the full adder cell and by a second input to receive the first configuration signal, such that the output of the first XOR gate outputs the MSB of a ready sum vector.

13. The multiply apparatus of claim 12, wherein the full adder cell at the most significant position of the CPA unit is coupled to a second XOR gate, an output of the second XOR gate being coupled to a summing input of the full adder cell, one input of the second XOR gate being coupled to receive the MSB of the third operand, and another input of the second XOR gate being coupled to receive the first configuration signal in order to switch between singed and unsigned operation.

14. A method for multiplying a first operand consisting of na bits and a second operand consisting of nx bits, the multiply apparatus comprising:
calculating a single bit product of two single bit input values and adder cells for adding results of a preceding row to a following row and a last output row for outputting a carry vector and a sum vector via a CSA unit with nx rows each comprising na AND gates; and
selectively inverting the single bit products at the most significant position of the nx−1 first rows and at the na−1 least significant positions of the output row in response to a first configuration signal before inputting the selectively inverted single bit products to respective adder cells for switching the CSA unit selectively between processing of signed two's complement operands and unsigned operands in response to the first configuration signal.

15. The method of claim 14 further comprising adding the carry vector and the sum vector provided at the output row of the CSA unit via a CPA unit being coupled to the output row of the CSA unit, wherein the CPA unit is consisting of a row of na−1 full adder cells, and wherein the carry input of the CPA unit is coupled to receive the first configuration signal to switch between processing of signed and unsigned two's complement operands.

16. The method of claim 15, wherein the full adder cell at the most significant position of the CPA unit is coupled to a first XOR gate being coupled by a first input to the carry output of the full adder cell and by a second input to receive the first configuration signal (tc), such that the output of the first XOR gate outputs the MSB of a ready sum vector.

17. The method of claim 14 further comprising adding a third operand to the product of the first and second operand so as to perform a multiply and accumulate operation.

18. The method of claim 17, wherein the method is adapted to multiply the first operand and a fourth operand consisting of nb=na bits, the method further comprising:
receiving the carry vector and receiving the sum vector;
inputting nx bit wide portions of the second operand to the carry save unit, wherein nb is ns times nx, ns being a positive integer in order to process the entire multiplication in ns slices, one slice for each portion of the second operand thereby consecutively calculating a product of the first operand and the second operand to be finalized after the last slice;
a first feedback connection coupling the first register and the second register back to the CSA unit for feeding back the temporary sum vector and the temporary carry vector to the CSA unit for processing of the respective following slice; and
logic circuitry for switching the CSA unit selectively between processing of the last slice and previous slices in response to a second configuration signal, such that the single bit products at the na−1 least significant positions of the last row are only inverted for the last slice of a signed two's complement operation and the single bit product at the most significant position of the last row is always inverted for signed two's complement operation except for the last slice.

19. The method of claim 18 further comprising feeding back the summing result in the CPA to the most significant part of the sum vector.

20. A method for multiplying a first operand consisting of na bits and a second operand consisting of nx bits, comprising:
outputting a carry vector and a sum vector; and
adding the carry vector and the sum vector provided by the output row of the CSA unit via a CPA unit consisting of a row of na full adder cells, wherein the carry input of the CPA unit is coupled to receive a first configuration signal (tc) to switch between processing of signed and unsigned two's complement operands.

21. The method of claim 20, wherein the full adder cell at the most significant position of the CPA unit is coupled to a first XOR gate being coupled by a first input to the carry output of the full adder cell and by a second input to receive the first configuration signal, such that the output of the first XOR gate outputs the MSB of a ready sum vector.

22. The method of claim 21, wherein the full adder cell at the most significant position of the CPA unit is coupled to a second XOR gate, an output of the second XOR gate being coupled to a summing input of the full adder cell, one input of the second XOR gate being coupled to receive the MSB of the third operand, and another input of the second XOR gate being coupled to receive the first configuration signal in order to switch between singed and unsigned operation.
